(19) United States
(12) Patent Application Publication
(10) Pub. No.: US 2026/0093900 A1
(43) Pub. Date: Apr. 2, 2026

(54) DEVICE, A DATA STRUCTURE, AND A COMPUTER IMPLEMENTED METHOD FOR EDITING A MODEL

(71) Applicant: Robert Bosch GmbH, Stuttgart (DE)

(72) Inventors: Mingyang Wang, Muenchen (DE); Heike Adel-Vu, Renningen (DE); Lukas Lange, Pforzheim (DE)

(21) Appl. No.: 19/342,750

(22) Filed: Sep. 29, 2025

(30) Foreign Application Priority Data
Oct. 2, 2024 (DE) 10 2024 209 698.9

(51) Int. Cl. G06F 40/166; G06F 16/3329

(52) U.S. Cl. CPC G06F 40/166; G06F 16/3329

(57) ABSTRACT

A device, a data structure, and a computer implemented method for editing a model. The method includes: providing the model with parameters; providing a first factual sentence representing a fact to be edited, wherein the fact to be edited includes a subject, a relation, and an object, wherein the first factual sentence represents the subject and the relation; providing a second factual sentence representing a fact to be maintained; determining a prompt for requesting the model to output the object, wherein the prompt includes a concatenation of the sentences; and editing at least one parameter of the model depending on a conditional likelihood conditioned on the subject and the relation that the model outputs a concatenation of the object and the second factual sentence in response to the prompt.

### CROSS REFERENCE

The present application claims the benefit under 35 U.S.C. § 119 of Germany Patent Application No. DE 10 2024 209 698.9 filed on Oct. 2, 2024, which is expressly incorporated herein by reference in its entirety.

### BACKGROUND INFORMATION

Model editing aims to modify specific knowledge stored in neural models, e.g., large language models (LLMs), without negatively impacting unrelated knowledge.

LLMs trained on massive corpora have been shown to implicitly store factual knowledge in their parameters. Despite their remarkable progress, the facts induced by LLMs can be incorrect or become obsolete in a changing world. The need to modify their stored knowledge without disrupting their overall functionality becomes crucial.

Example applications are LLM based Chatbots that are learned once. A crucial part is keeping the Chatbot's knowledge up-to-date which can be achieved with our method.

Meng, Kevin, et al. “Locating and editing factual associations in GPT;” Advances in Neural Information Processing Systems 35 (2022) and Meng, Kevin, et al. “Mass-Editing Memory in a Transformer;” The Eleventh International Conference on Learning Representations (2022) describe methods that identify a subset of parameters associated with specific knowledge and then modify them via direct weight updates.

However, these locate-and-edit methods incur heavy computational overhead and lack theoretical validation.

In contrast, directly fine-tuning the model on requested edits, though simple, has proven to perform poorly. It affects the model's behavior on irrelevant knowledge (i.e., it unlearns other knowledge), and significantly damages the model's generation fluency and consistency.

Gangadhar, Govind, and Karl Stratos. “Model Editing by Pure Fine-Tuning;” arXiv preprint arXiv:2402.11078 (2024) describes a method that utilizing data augmentation with paraphrase and random facts to the requested edits significantly improves the model editing performance via pure fine-tuning [Gangadhar and Stratos, 2024]. However, this method still suffers from generation failure.

### SUMMARY

A computer implemented method according to certain features of the present invention provides model editing of a model, in particular a LLM, that uses sentence concatenation with augmented random facts for generation regularization to address the challenges of model editing by fine-tuning.

According to an example embodiment of the present invention, the method utilizes sentence concatenation to avoid overfitting on the target output of the model, thus maintaining the model's generation quality. The method additionally uses random facts for data augmentation to effectively preserve the model's knowledge of irrelevant facts.

The model may be a model for analyzing text data of different languages and domains.

The method may be applied in real-world model editing applications where certain knowledge stored in the large language models needs to be altered.

The method updates specific knowledge within the model, e.g., the LLM, while keeping other irrelevant knowledge unchanged. The method is based on fine-tuning which does not require any pre-processing steps, thus being computationally efficient. The method uses fine-tuning-based model editing, i.e., fine-tuning of the model directly on the requested edits without any pre-processing steps.

The method addresses the challenges of catastrophic forgetting and knowledge transfer in continual learning, a crucial aspect in the deployment of machine learning models in dynamic environments.

The method is effective because it mitigates to affect the model's behavior on irrelevant knowledge out of the editing scope and it mitigates complete generation failure, wherein the generation quality of the fine-tuned model is completely damaged.

The sentence concatenation with augmented random facts enforces regularization. The sentence concatenation strategy aims to avoid the generation failure challenge while keeping the editing effectiveness.

According to an example embodiment of the present invention, the computer implemented method for editing the model comprises providing the model with parameters, providing a first factual sentence representing a fact to be edited, wherein the fact to be edited comprises a subject, a relation, and an object, wherein the first factual sentence represents the subject and the relation, providing a second factual sentence representing a fact to be maintained, determining a prompt for requesting the model to output the object, wherein the prompt comprising a concatenation of the sentences, and editing at least one parameter of the model depending on a conditional likelihood conditioned on the subject and the relation that the model outputs a concatenation of the object and the second factual sentence in response to the prompt.

According to an example embodiment of the present invention, the method may comprise providing the model pre-trained on training data comprising a set of facts, sampling the fact to be maintained from the set of facts, determining the second factual sentence depending on the fact to be maintained. This means, the training data is used to provide the facts to be maintained.

Determining the first factual sentence may comprise providing a set of facts for editing, sampling the fact to be edited from the set of facts for editing, determining the first factual sentence depending on the fact to be edited. This means, the first factual sentence is determined based directly on the facts to be edited.

Determining the second factual sentence may comprise verifying that the fact to be maintained is not in the set of facts for editing, and determining the second factual sentence depending on the fact to be maintained upon successful verifying, or not determining the second factual sentence depending on the fact to be maintained otherwise. This avoids contradiction.

According to the present invention, a device for editing the model comprises at least one processor and at least one memory, wherein the at least one memory is configured to store the model and instructions that, when executed by the at least one processor, cause the device to execute a method of the present invention.

According to the present invention, A computer program for editing the model comprises computer-readable instructions that, when executed by a computer, cause the computer to execute the method of the present invention.

According to an example embodiment of the present invention, the present invention, a data structure for editing the model comprises at least one data field for the model, a first factual sentence representing a fact to be edited, wherein the fact to be edited comprises a subject, a relation, and an object, wherein the first factual sentence represents the subject and the relation, a second factual sentence representing a fact to be maintained, a prompt for requesting the model to output the object, wherein the prompt comprising a concatenation of the sentences, and a conditional likelihood conditioned on the subject and the relation that the model outputs a concatenation of the object and the second factual sentence in response to the prompt.

The data structure may comprise at least one data field for training data comprising a set of facts, and for the fact to be maintained, sampled from the set of facts.

The data structure may comprise at least one data field a set of facts for editing, and the fact to be edited sampled from the set of facts for editing.

The data structure may comprise at least one data field for a result of verifying that the fact to be maintained is not in the set of facts for editing.

Further examples of the present invention are derived from the following description and the figures.

### BRIEF DESCRIPTION OF THE DRAWINGS

FIG. 1 schematically depicts a device for editing a model, according to an example embodiment of the present invention.

FIG. 2 depicts a flowchart comprising steps of a method for editing the model, according to an example embodiment of the present invention.

FIG. 3 schematically depicts a data structure for editing the model, according to an example embodiment of the present invention.

### DETAILED DESCRIPTION OF EXAMPLE EMBODIMENTS

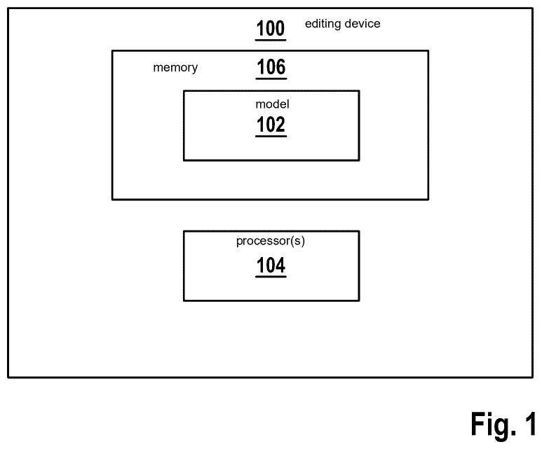

FIG. 1 schematically depicts a device 100 for editing a model 102. The model 102 is for example a Large Language Modell (LLM). The model 102 comprises parameters. The model 102 is for example a function ƒ_{θ} that depends on parameters θ of the model 102.

The model 102 is configured for example to output an object oᵢ of a fact (sᵢ, rᵢ, oᵢ) when prompted with a prompt pᵢ(sᵢ, rᵢ) comprising a subject sᵢ and a relation rᵢ of the fact.

The subject sᵢ is for example a first part of a sentence formulated in natural language. The relation rᵢ is for example a second part of the sentence formulated in natural language. The object oᵢ is for example a third part of the sentence formulated in natural language.

The prompt pᵢ is for example formulated as a natural language prompt, to the LLM. The prompt pᵢ comprises for example the subject sᵢ, the relation rᵢ and an interrogative formulated in natural language.

The device 100 comprises at least one processor 104 and at least one memory 106. The at least one processor 104 is configured to execute instructions, that when executed by the at least one processor 104 cause the device 100 to execute a method for editing the model 102. The at least one memory 106 is configured to store the instructions.

The at least one memory 106 is for example configured to store the model 102.

The device 100 is configured for editing the model 102 using sentence concatenation with augmented random facts for generation regularization.

The model 102 may be pre-trained on training data comprising a given set of M training data points

$$D = {\{ ( {s}_{i} , {r}_{i} , {o}_{i} ) \}}_{i = 1}^{M}$$

where (sᵢ, rᵢ, oᵢ) is a subject-relation-object triple that describes a fact (sᵢ, rᵢ, oᵢ) of the training data.

Editing the model 102 is described by way of example of editing the model 102 based on a given set of N edits

$$ℰ = {\{ ( {s}_{i} , {r}_{i} , {o}_{i} ) \}}_{i = 1}^{N}$$

where (sᵢ, rᵢ, oᵢ) is a subject-relation-object triple that describes a fact (sᵢ, rᵢ, oᵢ).

A factual sentence xᵢ∈ [symbol] ₑ=(pᵢ(sᵢ, rᵢ), oᵢ) is created from an object oᵢ that the model 102 outputs in response to a prompt pᵢ(sᵢ, rᵢ). The factual sentence xᵢ is for example formulated as a natural language sentence.

An example for the factual sentence xᵢ for a fact (Danielle Darrieux, is_mother_tongue, English) formulated as the natural language sentence is

The mother tongue of Danielle Darrieux is English.

An example for the prompt pᵢ(sᵢ, rᵢ) for the exemplary factual sentence xᵢ is

The mother tongue of Danielle Darrieux is which?

wherein “which?” represents the interrogative, “Danielle Darrieux” represents the subject sᵢ, and “The mother tongue of . . . is” represents the relation rᵢ.

A random factual sentence aᵢ∈A is provided from a set of factual sentences A. The set of factual sentences A comprises sentences that should not be altered by editing the model 102 based on the edits ε.

The random factual sentence aᵢ is for example formulated as a natural language sentence.

An example for the random factual sentence aᵢ formulated as the natural language sentence is

The capital of France is Paris.

According to an example, the random factual sentence at is determined based on a fact (sᵢ, rᵢ, oᵢ). The fact (sᵢ, rᵢ, oᵢ) for the random factual sentence aᵢ is for example (Paris, is_capital_of, France)

The random factual sentence aᵢ is for example determined based on a fact (sᵢ, rᵢ, oᵢ) from the training data D that is different from the facts in the edits ε.

The fact (sᵢ, rᵢ, oᵢ) for determining the random factual sentence aᵢ is for example sampled from the training data D and it is verified, that the fact (sᵢ, rᵢ, oᵢ) for determining the random factual sentence at is not a fact that is in the edits ε. The factual sentence x; and the random factual sentence aᵢ are concatenated to a concatenated prompt.

The model 102 is trained depending on the concatenated prompt.

The training objective of the method is to directly optimize

$${min}_{θ} - {\sum }_{( {s}_{i} , {r}_{i} , {o}_{i} , {a}_{i} ) ∈ ℰ ⋃ A} log {p}_{e} ( {o}_{i} , {a}_{i} \vert {s}_{i} , {r}_{i} )$$

wherein θ are the parameters of the model 102.

This means, the method directly optimizes the conditional likelihood log p_{θ}(oᵢ, aᵢ|sᵢ, rᵢ) conditioned on the subject sᵢ and relation rᵢ of the fact (sᵢ, rᵢ, oᵢ).

This means, the method directly optimizes the conditional likelihood log p_{θ}(oᵢ, aᵢ|sᵢ, rᵢ) of the output of the model 102 in response to the prompt pᵢ being the target object oᵢ concatenated with the random factual sentence aᵢ.

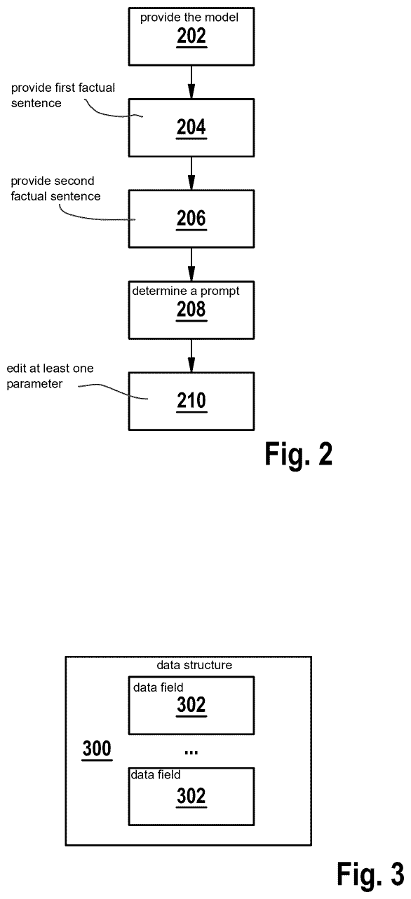

FIG. 2 depicts a flowchart comprising steps of the method. The steps of the method are described by way of example of one edit. According to an example, the method processes the N edits to optimize the training objective.

The method comprises a step 202.

The step 202 comprises providing the model 102, e.g., ƒ_{θ}, with the parameters θ.

The model 102 is for example pre-trained on training data comprising a set of facts, e.g. the training data points D.

The method comprises a step 204.

The step 204 comprises providing a first factual sentence xᵢ representing a fact to be edited.

The fact to be edited comprises a subject sᵢ, a relation rᵢ, and an object oᵢ.

The first factual sentence represents the subject sᵢ, and the relation rᵢ.

For example, a set of facts for editing is provided, e.g., the edits ε.

The fact to be edited is for example sampled from the set of facts for editing.

The first factual sentence is for example determined depending on the sampled fact to be edited.

The method comprises a step 206.

The step 206 comprises providing a second factual sentence aᵢ representing a fact to be maintained. The second factual sentence aᵢ is for example the random factual sentence aᵢ.

The fact to be maintained is for example sampled from the set of facts from the training data. The second factual sentence is for example determined depending on the sampled fact to be maintained.

Determining the second factual sentence may comprise verifying that the fact to be maintained is not in the set of facts for editing.

The second factual sentence is for example determined depending on the fact to be maintained upon successful verifying and not determined depending on the fact to be maintained otherwise.

The method comprises a step 208.

The step 208 comprises determining a prompt pᵢ for requesting the model 102 to output the object.

The prompt pᵢ comprises a concatenation of the sentences, i.e., first factual sentence xᵢ and second factual sentence aᵢ.

The method comprises a step 210.

The step 210 comprises editing at least one parameter of the model 102, e.g. one of the parameters θ, depending on the conditional likelihood conditioned on the subject and the relation that the model 102 outputs a concatenation of the object and the second factual sentence in response to the prompt.

For example, the training objective of the method is directly optimized to determine the at least one parameter.

FIG. 3 schematically depicts a data structure 300 for editing the model 102.

The data structure 300 comprises at least one data field 302 for
the model 102,
the first factual sentence,
the second factual sentence,
the prompt, and
the conditional likelihood.

The data structure 300 may comprise at least one data field 302 for
the training data,
the fact to be maintained,
the set of facts for editing,
the fact to be edited, and/or
the result of verifying that the fact to be maintained is not in the set of facts for editing.

What is claimed is:

1. A computer implemented method for editing a model, the method comprising the following steps:
providing the model with parameters;
providing a first factual sentence representing a fact to be edited, wherein the fact to be edited includes a subject, a relation, and an object, wherein the first factual sentence represents the subject and the relation;
providing a second factual sentence representing a fact to be maintained;
determining a prompt for requesting the model to output the object, wherein the prompt includes a concatenation of the first factual sentence and the second factual sentence; and
editing at least one parameter of the model depending on a conditional likelihood conditioned on the subject and the relation that the model outputs a concatenation of the object and the second factual sentence in response to the prompt.

2. The method according to claim 1, further comprising:
providing the model pre-trained on training data including a set of facts;
sampling the fact to be maintained from the set of facts; and
determining the second factual sentence depending on the fact to be maintained.

3. The method according to claim 1, wherein the first factual sentence is determined by providing a set of facts for editing, sampling the fact to be edited from the set of facts for editing, and determining the first factual sentence depending on the fact to be edited.

4. The method according to claim 2, wherein the determining of the second factual sentence includes verifying that the fact to be maintained is not in the set of facts for editing, and: (i) determining the second factual sentence depending on the fact to be maintained upon successful verifying, or (ii) not determining the second factual sentence depending on the fact to be maintained otherwise.

5. A device for editing a model, comprising:
at least one processor; and
at least one non-transitory memory, wherein the at least one non-transitory memory s configured to store the model and instructions that, when executed by the at least one processor, cause the device to execute a method for editing a model, the method including the following steps:
providing the model with parameters,
providing a first factual sentence representing a fact to be edited, wherein the fact to be edited includes a subject, a relation, and an object, wherein the first factual sentence represents the subject and the relation,
providing a second factual sentence representing a fact to be maintained,
determining a prompt for requesting the model to output the object, wherein the prompt includes a concatenation of the first factual sentence and the second factual sentence, and
editing at least one parameter of the model depending on a conditional likelihood conditioned on the subject and the relation that the model outputs a concatenation of the object and the second factual sentence in response to the prompt.

6. A non-transitory computer-readable medium on which is stored a computer program for editing a model, the computer program comprising computer-readable instructions that, when executed by a computer, cause the computer to execute a method for editing a model, the method comprising the following steps:
providing the model with parameters;
providing a first factual sentence representing a fact to be edited, wherein the fact to be edited includes a subject, a relation, and an object, wherein the first factual sentence represents the subject and the relation;
providing a second factual sentence representing a fact to be maintained;
determining a prompt for requesting the model to output the object, wherein the prompt includes a concatenation of the first factual sentence and the second factual sentence; and
editing at least one parameter of the model depending on a conditional likelihood conditioned on the subject and the relation that the model outputs a concatenation of the object and the second factual sentence in response to the prompt.

7. A data structure for editing a model, comprising:
at least one data field for the model, a first factual sentence representing a fact to be edited, wherein the fact to be edited includes a subject, a relation, and an object, wherein the first factual sentence represents the subject and the relation, a second factual sentence representing a fact to be maintained, a prompt for requesting the model to output the object, wherein the prompt includes a concatenation of the sentences, and a conditional likelihood conditioned on the subject and the relation that the model outputs a concatenation of the object and the second factual sentence in response to the prompt.

8. The data structure according to claim 7, further comprising:
at least one data field for training data including a set of facts, and for the fact to be maintained, sampled from the set of facts.

9. The data structure according to claim 7, further comprising:
at least one data field for a set of facts for editing, and the fact to be edited sampled from the set of facts for editing.

10. The data structure according to claim 9, further comprising:
at least one data field for a result of verifying that the fact to be maintained is not in the set of facts for editing.
